(19) United States
(12) Patent Application Publication
(10) Pub. No.: US 2018/0371235 A1
(43) Pub. Date: Dec. 27, 2018

(54) POLYCARBONATE RESIN COMPOSITION AND MOLDED PRODUCT THEREOF

(71) Applicant: IDEMITSU KOSAN CO., LTD., Tokyo (JP)

(72) Inventor: Nobuhiro WATANABE, Chiba-shi (JP)

(73) Assignee: IDEMITSU KOSAN CO., LTD., Tokyo (JP)

(21) Appl. No.: 15/776,710

(22) PCT Filed: Nov. 8, 2016
(86) PCT No.: PCT/JP2016/083093

§ 371 Date: May 16, 2018

(30) Foreign Application Priority Data
Nov. 20, 2015 (JP) 2015-227963

(51) Int. Cl. C08L 69/00; G02B 1/04

(52) U.S. Cl. CPC C08L 69/00; C08L 2205/06; C08L 2201/08; G02B 1/045

(57) ABSTRACT

Provided are a polycarbonate resin composition (1) containing, with respect to 100 parts by mass of (A) a polycarbonate resin, 0.01 part by mass to 0.25 part by mass of (B) a silicone compound, and 0.015 part by mass to 0.25 part by mass of (C) an ester of an aliphatic carboxylic acid having 12 to 22 carbon atoms and glycerin, wherein a sodium content in the component (B) is 15 ppm by mass or less, or a polycarbonate resin composition (2) containing, with respect to 100 parts by mass of the component (A), 0.01 part by mass to 0.25 part by mass of the component (B), and 0.015 part by mass to 0.25 part by mass of the component (C), wherein the modification ratio of the component (C) is 30% or less, and a molded article obtained from the polycarbonate resin composition (1) or (2).

### TECHNICAL FIELD

The present invention relates to a polycarbonate resin composition and a molded article thereof, and more specifically, to a polycarbonate resin composition in which even under severe molding conditions, such as high-temperature molding and a long retention time, a molded article hardly yellows, its releasability is not reduced, and the occurrence of an appearance failure of the molded article, such as silver, can be prevented, and a molded article thereof.

### BACKGROUND ART

A polycarbonate resin has excellent features, such as transparency, heat resistance, and mechanical characteristics, and hence has been used in a wide variety of applications including: casings for OA equipment and a home electric appliance, and members in an electrical and electronic field; optical materials, such as various optical disc substrates and lenses; carport roof materials; and various building materials. In addition, the production amount and applications of the resin have been increasing. In view of such background, various resin constructions that can bear various applications have been invented, and in, for example, Patent Document 1, there is a description that a molded body having not only excellent weatherability and excellent transparency but also satisfactory releasability is obtained by using a full ester of pentaerythritol and an aliphatic carboxylic acid, the full ester having a sodium content of 15 ppm or less, as a release agent, and a benzotriazole-based UV absorber. The molded body is assumed to be used particularly outdoors or indoors under irradiation with fluorescent light, and particularly when a UV-absorbing effect is required. The contents of the invention are as described below. To cope with a problem in that when the full ester of pentaerythritol and the aliphatic carboxylic acid serving as a release agent, and the benzotriazole-based UV absorber are used in combination, the effect of the UV absorber is not sufficiently exhibited, the sodium content is specified to achieve the effect. In the invention, however, no investigation has been made on the obtainment of a molded article that hardly causes silver or the like and is hence excellent in appearance.

In addition, in Patent Document 2, there is a description of an aromatic polycarbonate resin composition for a thin plate-storing/conveying container, and there is a description that an ester of a polyhydric alcohol and a higher fatty acid is incorporated into an aromatic polycarbonate resin, and a sodium content in the composition is set to 0.1 ppm or less. In Patent Document 2 described above, the surface contamination of a thin plate, such as a semiconductor wafer or a magnetic disk, which is considered to be sensitive to surface contamination, can be reduced, and the releasability of the composition at the time of its molding is improved.

As described above, in each of Patent Documents 1 and 2 described above, there are no descriptions of a polycarbonate resin composition that can suppress the yellowing of a molded article and prevent the occurrence of an appearance failure of the molded article, such as silver, without reducing the releasability of the molded article in the production of an optical part through the use of a polycarbonate resin, and a molded article thereof.

### CITATION LIST

### Patent Document

Patent Document 1: JP 2012-251013 A

Patent Document 2: WO 2012/141336 A1

### SUMMARY OF INVENTION

### Technical Problem

An object of the present invention is to provide a polycarbonate resin composition in which even under severe molding conditions, such as high-temperature molding and a long retention time, the molded article hardly yellows, its releasability is not reduced, and the occurrence of an appearance failure of the molded article, such as silver, can be prevented, and a molded article thereof.

### Solution to Problem

The inventor of the present invention has made extensive investigations, and as a result, has found that an optical molded article having the following feature is obtained by using a silicone compound having a low sodium content, and an ester of glycerin and a higher fatty acid in combination with a polycarbonate resin: even under severe molding conditions, such as high-temperature molding and a long retention time, its releasability is not reduced, the molded article hardly yellows, and the occurrence of an appearance failure of the molded article, such as silver, can be prevented. Thus, the inventor has completed the present invention.

That is, the present invention relates to the following items [1] to [16].
[1] A polycarbonate resin composition, comprising: a polycarbonate resin serving as a component (A); a silicone compound serving as a component (B); and an ester of an aliphatic carboxylic acid having 12 to 22 carbon atoms and glycerin serving as a component (C), wherein the polycarbonate resin composition comprises, with respect to 100 parts by mass of the component (A), 0.01 part by mass or more and 0.25 part by mass or less of the component (B), and 0.015 part by mass or more and 0.25 part by mass or less of the component (C), and wherein a sodium content in the component (B) is 15 ppm by mass or less.
[2] The polycarbonate resin composition according to the above-mentioned item [1], wherein a sodium content in the component (A) is 200 ppb by mass or less.
[3] The polycarbonate resin composition according to the above-mentioned item [1] or [2], wherein a sodium content in the component (C) is 2 ppm by mass or less.
[4] The polycarbonate resin composition according to any one of the above-mentioned items [1] to [3], wherein the component (C) comprises an ester of stearic acid and glycerin.
[5] The polycarbonate resin composition according to the above-mentioned item [4], wherein the ester of stearic acid and glycerin comprises glycerin monostearate.
[6] The polycarbonate resin composition according to any one of the above-mentioned items [1] to [5], wherein the component (B) comprises a silicone compound in which at least one kind selected from the group consisting of a hydrogen atom, an alkoxy group, a hydroxy group, an epoxy group, and a vinyl group is bonded to a silicon atom.
[7] The polycarbonate resin composition according to any one of the above-mentioned items [1] to [6], wherein the component (A) comprises an aromatic polycarbonate resin.
[8] The polycarbonate resin composition according to any one of the above-mentioned items [1] to [7], wherein the component (A) has a viscosity-average molecular weight of 9,000 or more and 30,000 or less.
[9] The polycarbonate resin composition according to any one of the above-mentioned items [1] to [7], wherein the component (A) has a viscosity-average molecular weight of 10,000 or more and 20,000 or less.
[10] The polycarbonate resin composition according to any one of the above-mentioned items [1] to [9], further comprising, with respect to 100 parts by mass of the component (A), 0.01 part by mass to 0.5 part by mass of an acrylic resin serving as a component (D).
[11] The polycarbonate resin composition according to any one of the above-mentioned items [1] to [10], further comprising, with respect to 100 parts by mass of the component (A), 0.003 part by mass to 0.2 part by mass of an antioxidant serving as a component (E).
[12] A polycarbonate resin composition, comprising: a polycarbonate resin serving as a component (A); a silicone compound serving as a component (B); and an ester of an aliphatic carboxylic acid having 12 to 22 carbon atoms and glycerin serving as a component (C), wherein the polycarbonate resin composition comprises, with respect to 100 parts by mass of the component (A), 0.01 part by mass or more and 0.25 part by mass or less of the component (B), and 0.015 part by mass or more and 0.25 part by mass or less of the component (C), and wherein a modification ratio of the component (C) in the polycarbonate resin composition is 30% or less.
[13] A molded article, which is obtained by molding the polycarbonate resin composition of any one of the above-mentioned items [1] to [12].
[14] The molded article according to the above-mentioned item [13], wherein the molded article comprises an optical molded article.
[15] The molded article according to the above-mentioned item [14], wherein the optical molded article comprises a light-guiding plate for a liquid crystal panel.
[16] The molded article according to the above-mentioned item [15], wherein the optical molded article comprises a light-guiding part for a vehicle.

### Advantageous Effects of Invention

The molded article having the following feature can be obtained by using the polycarbonate resin composition of the present invention: even under severe molding conditions, such as high-temperature molding and a long retention time, the molded article hardly yellows, its releasability is not reduced, and the occurrence of an appearance failure of the molded article, such as silver, can be prevented.

### DESCRIPTION OF EMBODIMENTS

Polycarbonate resin compositions (1) and (2) and molded articles thereof of the present invention are described in detail below. In this description, a specification considered to be preferred can be arbitrarily adopted, and a combination of preferred specifications can be said to be more preferred. In addition, the term “A to B” as used herein concerning the description of a numerical value means “A or more and B or less” (when A<B) or “A or less and B or more” (when A>B).

A polycarbonate resin composition of the present invention comprises: a polycarbonate resin composition, comprising: a polycarbonate resin serving as a component (A); a silicone compound serving as a component (B); and an ester of an aliphatic carboxylic acid having 12 to 22 carbon atoms and glycerin serving as a component (C), wherein the polycarbonate resin composition comprises, with respect to 100 parts by mass of the component (A), 0.01 part by mass or more and 0.25 part by mass or less of the component (B), and 0.015 part by mass or more and 0.25 part by mass or less of the component (C), and wherein a sodium content in the component (B) is 15 ppm by mass or less [referred to as polycarbonate resin composition (1)]; and a polycarbonate resin composition, comprising: a polycarbonate resin serving as a component (A); a silicone compound serving as a component (B); and an ester of an aliphatic carboxylic acid having 12 to 22 carbon atoms and glycerin serving as a component (C), wherein the composition comprises, with respect to 100 parts by mass of the component (A), 0.01 part by mass or more and 0.25 part by mass or less of the component (B), and 0.015 part by mass or more and 0.25 part by mass or less of the component (C), and wherein a modification ratio of the component (C) in the polycarbonate resin composition is 30% or less [referred to as polycarbonate resin composition (2)].

### [Polycarbonate Resin Composition (1)]

### <(A) Polycarbonate Resin>

In the polycarbonate resin composition (1) of the present invention, the polycarbonate resin is used as the component (A). The polycarbonate resin may be an aromatic polycarbonate resin or an aliphatic polycarbonate resin, but the aromatic polycarbonate resin is preferably used because the resin is more excellent in impact resistance and heat resistance.

### (Aromatic Polycarbonate Resin)

An aromatic polycarbonate resin produced by a reaction between an aromatic dihydric phenol and a carbonate precursor can be used as the aromatic polycarbonate resin. The aromatic polycarbonate resin can be used as a main component of the resin composition because the resin has satisfactory heat resistance, flame retardancy, and impact resistance as compared to any other thermoplastic resin.

Examples of the aromatic dihydric phenol may include: 4,4′-dihydroxydiphenyl; bis(4-hydroxyphenyl)alkanes, such as 1,1-bis(4-hydroxyphenyl)methane, 1,1-bis(4-hydroxyphenyl)ethane, and 2,2-bis(4-hydroxyphenyl)propane [bisphenol A]; bis(4-hydroxyphenyl)cycloalkanes; bis(4-hydroxyphenyl) oxide; bis(4-hydroxyphenyl) sulfide; bis(4-hydroxyphenyl) sulfone; bis(4-hydroxyphenyl) sulfoxide; and bis(4-hydroxyphenyl) ketone. Among them, bisphenol A is preferred. The aromatic dihydric phenol may be a homopolymer using one kind of the aromatic dihydric phenols, or may be a copolymer using two or more kinds thereof. Further, a thermoplastic and randomly branched polycarbonate resin obtained by using a polyfunctional aromatic compound and the aromatic dihydric phenol in combination is permitted.

Examples of the carbonate precursor include a carbonyl halide, a haloformate, and a carbonate ester. Specific examples thereof include phosgene, a dihaloformate of a dihydric phenol, diphenyl carbonate, dimethyl carbonate, and diethyl carbonate.

A terminal stopper can be used as required in the production of the aromatic polycarbonate resin to be preferably used in the present invention. A known terminal stopper in the production of an aromatic polycarbonate resin only needs to be used as the terminal stopper. Specific examples of such compound may include phenol, p-cresol, p-tert-butylphenol, p-tert-octylphenol, p-cumylphenol, p-nonylphenol, and p-tert-amylphenol. Those monohydric phenols may each be used alone, or two or more kinds thereof may be used in combination.

The aromatic polycarbonate resin to be preferably used in the present invention may have a branching structure. A branching agent only needs to be used to introduce the branching structure, and there may be used, for example, compounds each having three or more functional groups, such as 1,1,1-tris(4-hydroxyphenyl)ethane, α,α′,α″-tris(4-hydroxyphenyl)-1,3,5-triisopropylbenzene, 1-[α-methyl-α-(4′-hydroxyphenyl)ethyl]-4-[α′,α′-bis(4″-hydroxyphenyl)ethyl]benzene, phloroglucin, trimellitic acid, and isatinbis(o-cresol).

The viscosity-average molecular weight (Mv) of the polycarbonate resin serving as the component (A) to be used in the present invention is preferably from 9,000 to 40,000, more preferably from 9,000 to 30,000, still more preferably from 10,000 to 30,000, still further more preferably from 14,000 to 30,000 from the viewpoints of the physical properties of a resin composition, such as a mechanical strength. In addition, from the viewpoint that the resin composition is turned into an optical molded article, such as a light-guiding part, the viscosity-average molecular weight is preferably from 9,000 to 20,000, more preferably from 10,000 to 20,000, still more preferably from 11,000 to 18,000 in consideration of the moldability of the composition. The viscosity-average molecular weight (Mv) can be calculated from Schnell's equation ([η]=1.23×10⁻⁵ Mv⁸³)by measuring a limiting viscosity [η] through the measurement of the viscosity of a methylene chloride solution at 20° C. [concentration: g/L] with an Ubbelohde type viscometer.

In addition, in the present invention, when an aromatic polycarbonate-polyorganosiloxane copolymer, or a resin containing the aromatic polycarbonate-polyorganosiloxane copolymer is used as the polycarbonate resin, flame retardancy and impact resistance at low temperature can be improved. A polyorganosiloxane forming the copolymer is more preferably polydimethylsiloxane in terms of flame retardancy.

### <(B) Silicone Compound>

The polycarbonate resin composition (1) of the present invention contains the silicone compound as the component (B). The silicone compound serving as the component (B) is used because the compound has the following effects: when the polycarbonate resin composition (1) of the present invention is pelletized, the compound acts like a lubricant to suppress the yellowing of a molded article of the composition; and when the composition is molded, the compound prevents an appearance failure, such as silver.

A silicone compound having a hydrocarbon group having 1 to 12 carbon atoms on a silicon atom typified by a compound such as a polydimethylsiloxane, a polymethylethylsiloxane, or a polymethylphenylsiloxane can be used as the silicone compound serving as the component (B).

A straight silicone oil and a modified silicone oil can also each be used as the silicone compound serving as the component (B).

The straight silicone oil is a silicone compound in which an organic group bonded to a silicon atom is a methyl group, a phenyl group, or a hydrogen atom. Specific examples of the straight silicone oil include a dimethyl silicone oil in which all the side chains and terminals of a polysiloxane are methyl groups, a methyl phenyl silicone oil in which part of the side chains of a polysiloxane are phenyl groups, and a methyl hydrogen silicone oil in which part of the side chains of a polysiloxane are hydrogen atoms.

The modified silicone oil is a silicone compound obtained by introducing an organic group into a side chain or terminal of the straight silicone oil, and such oils are classified into a side-chain type oil, a two-terminal type oil, a one-terminal type oil, and a side-chain/two-terminal type oil in accordance with the position at which the organic group is introduced. Examples of the organic group to be introduced into the modified silicone oil include a hydrogen atom, an alkyl group, an aryl group, an aralkyl group, a fluoroalkyl group, an amino group, an amide group, an epoxy group, a mercapto group, a carboxy group, a polyether group, a hydroxy group, an alkoxy group, an aryloxy group, a polyoxyalkylene group, a vinyl group, an acryloyl group, and a methacryloyl group.

The silicone compound serving as the component (B) is preferably a polymer or copolymer formed of a structural unit represented by the following formula, and is preferably a silicone compound in which at least one kind selected from the group consisting of a hydrogen atom, an alkoxy group, a hydroxy group, an epoxy group, and a vinyl group is bonded to a silicon atom:

(R¹)ₐ(R²)_{b}SiO_{(4-a-b)/2}

wherein: R¹ represents at least one kind selected from the group consisting of a hydrogen atom, an alkoxy group, a hydroxy group, an epoxy group, and a vinyl group; R² represents a hydrocarbon group having 1 to 12 carbon atoms; and a and b each represent an integer satisfying 0<a≤3, 0≤b<3, and 0<a+b≤3.

R¹ preferably represents a methoxy group or a vinyl group. In addition, examples of the hydrocarbon group represented by R² include a methyl group, an ethyl group, and a phenyl group.

Among the silicone compounds, a functional group-containing silicone compound formed of a structural unit containing a phenyl group as a hydrocarbon group represented by R² in the formula shows particularly high usefulness when used as the component (B) in the present invention. In addition, a compound containing one kind of organic group as an organic group represented by R¹ in the formula may be used, a compound containing two or more different kinds of organic groups as such organic groups may be used, or a mixture of these compounds may be used. In addition, a compound in which a value for a ratio “organic group (R¹)/hydrocarbon group (R²)” in the formula is from 0.1 to 3, preferably from 0.3 to 2 is suitably used. Further, the silicone compound may be liquid or powdery. When the compound is liquid, its viscosity at room temperature is preferably from about 10 cSt to about 500,000 cSt. In addition, when the polycarbonate resin composition is used in optical applications, a difference in refractive index between the silicone compound and the polycarbonate resin is preferably made as small as possible, and the refractive index of the silicone compound is preferably from 1.45 to 1.65, more preferably from 1.48 to 1.60.

In the polycarbonate resin composition (1) of the present invention, the sodium content in the silicone compound serving as the component (B) needs to be 15 ppm by mass or less. A case in which the sodium content in the component (B) is more than 15 ppm by mass is not preferred because when a molded article is obtained by using the polycarbonate resin composition, the yellow index of the molded article increases. When sodium is incorporated at a content of more than 15 ppm by mass, part of the ester of the aliphatic carboxylic acid having 12 to 22 carbon atoms and glycerin serving as the component (C) is turned into a modified product, and hence the modified product is also assumed to be responsible for the yellowing of the molded article. The sodium content in the component (B) is preferably 10 ppm by mass or less. A commercial compound can be used as the component (B). However, even the sodium content of the commercial product may fluctuate, and even products that are available from the same manufacturer and are of the same grade may be different from each other in sodium content. Therefore, when the component (B) is used, the following procedure needs to be adopted: the sodium content in the component (B) is examined in advance, and the component (B) having a low sodium content is used; or the component is used after its sodium content has been reduced. The component (B) is colored pale yellow in some cases, and hence the component (B) colored to a small extent is preferably used.

A method involving performing an adsorption treatment with, for example, aluminum hydroxide, a synthetic hydrotalcite, magnesium silicate, aluminum silicate, or activated carbon has been known as a method of reducing the amount of a metal component, such as sodium, described above.

<(C) Ester of Aliphatic Carboxylic Acid having 12 to 22 Carbon Atoms and Glycerin>

In the present invention, (C) the ester of the aliphatic carboxylic acid having 12 to 22 carbon atoms and glycerin is used for improving releasability when the polycarbonate resin composition (1) of the present invention is molded. The ester of the aliphatic carboxylic acid having 12 to 22 carbon atoms and glycerin is obtained by subjecting the aliphatic carboxylic acid having 12 to 22 carbon atoms and glycerin to an esterification reaction to provide a monoester, a diester, or a triester. Herein, examples of the aliphatic carboxylic acid having 12 to 22 carbon atoms may include: saturated aliphatic carboxylic acids, such as dodecanoic acid, tridecanoic acid, tetradecanoic acid, pentadecanoic acid, hexadecanoic acid (palmitic acid), heptadecanoic acid, octadecanoic acid (stearic acid), and nonadecanoic acid; and unsaturated aliphatic carboxylic acids, such as oleic acid, linoleic acid, and linolenic acid. Among them, an aliphatic carboxylic acid having 14 to 20 carbon atoms is preferred, and stearic acid and palmitic acid are particularly preferred.

The aliphatic carboxylic acid, such as stearic acid, is often a mixture that is produced from a natural oil and fat, and contains any other carboxylic acid component having a different number of carbon atoms. Also in the fatty acid ester, an ester compound obtained from stearic acid or palmitic acid in the form of a mixture that is produced from a natural oil and fat, and contains any other carboxylic acid component is preferably used.

Specific example of the ester compound include ester compounds each containing glycerin monostearate, glycerin distearate, glycerin tristearate, glycerin monopalmitate, glycerin monobehenate, or the like as a main component. Among them, an ester compound containing glycerin monostearate or glycerin monopalmitate as a main component is preferably used. A compound having a monoglyceride ratio of 95% or more is more preferably used.

The component (C) is preferably an ester of stearic acid and glycerin, more preferably glycerin monostearate.

With regard to sodium contents in the component (A) and the component (C), as in the component (B), the component (A) and the component (C) each having a low sodium content are preferably used from the viewpoint of suppressing the production of the modified product considered to be derived from the component (C). The sodium content in the component (A) is preferably set to 200 ppb by mass or less, and the sodium content in the component (C) is set to preferably 10 ppm by mass or less, more preferably 5 ppm by mass or less, still more preferably 2 ppm by mass or less.

The sodium (Na) contents in the raw materials to be used were each determined by: adding sulfuric acid to 5 g of each of the measurement samples (raw materials to be used); subjecting the mixture to a heat ashing treatment; then dissolving the resultant in an aqueous solution of hydrochloric acid; and subjecting the aqueous solution to measurement based on inductively coupled plasma-atomic emission spectroscopy (ICP-AES). A determination lower limit by the measurement is 200 ppb by mass.

### <Contents of Component (B) and Component (C)>

In the polycarbonate resin composition (1) of the present invention, the content of the silicone compound serving as the component (B) needs to be from 0.01 part by mass to 0.25 part by mass with respect to 100 parts by mass of the polycarbonate resin serving as the component (A). A case in which the content of the component (B) is less than 0.01 part by mass is not preferred because when a molded article is obtained by using the polycarbonate resin composition (1), the heat stability of the molded article may reduce, and an appearance failure, such as silver, may occur on the surface of the molded article. In addition, a case in which the component (B) is incorporated at a content of more than 0.25 part by mass is also not preferred because the heat stability of the molded article cannot be further improved, but rather its YI is increased by a difference in refractive index between the component (B) and the polycarbonate resin serving as the component (A), and hence its light transmittance is impaired. The content of the component (B) is preferably from 0.03 part by mass to 0.20 part by mass, more preferably from 0.05 part by mass to 0.15 part by mass. The content of the component (B) in the polycarbonate resin composition (1) can be measured by gas chromatography, but the content of the component (B) does not largely change from its blending amount before the melt kneading of the components of the composition.

In the polycarbonate resin composition (1) of the present invention, the content of the ester of the aliphatic carboxylic acid having 12 to 22 carbon atoms and glycerin serving as the component (C) needs to be from 0.015 part by mass to 0.25 part by mass with respect to 100 parts by mass of the polycarbonate resin serving as the component (A). A case in which the content of the component (C) is less than 0.015 part by mass is not preferred because when a molded article is obtained by using the polycarbonate resin composition, its releasability deteriorates. In addition, a case in which the content of the component (C) is more than 0.25 part by mass is not preferred because there is a risk in that the component (C) adheres to the surface of a mold to adversely affect the surface appearance of a product. The content of the component (C) is preferably from 0.015 part by mass to 0.18 part by mass, more preferably from 0.03 part by mass to 0.10 part by mass. The content of the component (C) in the polycarbonate resin composition (1) can be measured by gas chromatography.

### <Modified Product of Component (C)>

The polycarbonate resin composition (1) of the present invention is obtained by kneading predetermined amounts of the component (A), the component (B), the component (C), and as required, any other component. An extensive investigation by the inventor has revealed that the ester of the aliphatic carboxylic acid having 12 to 22 carbon atoms and glycerin serving as the component (C) is liable to be modified by a production process for the composition, in particular, an influence by heat, and has found that a modified product of the component (C) is incorporated also into the polycarbonate resin composition (1) of the present invention by the kneading process. In particular, when the sodium content in the component (B) is more than 15 ppm by mass, the component (C) may be modified at a high modification ratio. The modified product may be, for example, a compound having a carbonate ester structure as a result of a reaction between the two hydroxy groups of a monoester. The modified product is assumed to be a cause for the yellowing of a molded article of the composition. The content of the modified product of the component (C) in the polycarbonate resin composition (1) can also be measured by gas chromatography. The modified product is represented by the following formula (I):

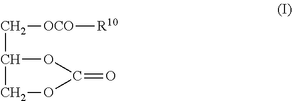

wherein in the formula (I), R¹⁰ represents an alkyl group having 11 to 21 carbon atoms.

### <Modification Ratio of Component (C)>

The modification ratio of the component (C) in the polycarbonate resin composition (1) of the present invention is preferably 30% or less. In the case where the modification ratio of the component (C) is set to 30% or less, when the pellet is turned into a molded article, an increase in yellow index of the molded article can be suppressed. The modification ratio of the component (C) can be determined as a ratio “[(content of modified product derived from component (C) in pellet)/[content of component (C) in pellet+content of modified product derived from component (C) in pellet]]×100 (%)” by measuring the content of the component (C) in the pellet formed of the polycarbonate resin composition (1) and the content of a modified product derived from the component (C) therein.

### <(D) Acrylic Resin>

An acrylic resin can be incorporated into the polycarbonate resin composition (1) of the present invention as a component (D) as required. The incorporation of the acrylic resin is suitable particularly in the case where a molded body obtained from the polycarbonate resin composition of the present invention is turned into an optical member, such as a light-guiding plate, because the total light transmittance can be improved by the incorporation. The acrylic resin that can be incorporated into the polycarbonate resin composition of the present invention refers to a polymer containing, as a repeating unit, a monomer unit of each of acrylic acid, an acrylic acid ester, acrylonitrile, and derivatives thereof, and refers to a homopolymer or a copolymer with, for example, styrene or butadiene. Specific examples thereof include a polyacrylic acid, a polymethyl methacrylate (PMMA), a polyacrylonitrile, an ethyl acrylate-2-chloroethyl acrylate copolymer, a n-butyl acrylate-acrylonitrile copolymer, an acrylonitrile-styrene copolymer, an acrylonitrile-butadiene copolymer, and an acrylonitrile-butadiene-styrene copolymer. Among them, a polymethyl methacrylate (PMMA) can be particularly suitably used. The polymethyl methacrylate (PMMA), which may be a known polymethyl methacrylate, is preferably a polymethyl methacrylate produced by subjecting a methyl methacrylate monomer to bulk polymerization in the presence of a peroxide or an azo-based polymerization initiator.

Further, the weight-average molecular weight of the acrylic resin serving as the component (D) is preferably from 200 to 100,000, more preferably from 20,000 to 60,000. When the weight-average molecular weight falls within the range, phase separation between the polycarbonate resin and the acrylic resin hardly occurs at the time of the molding of the composition, and hence a risk in that light-guiding performance when the resultant molded article is turned into a light-guiding plate is adversely affected reduces. When the acrylic resin serving as the component (D) is incorporated into the polycarbonate resin composition (1) of the present invention, its content is preferably from 0.01 part by mass to 0.5 part by mass, more preferably from 0.015 part by mass to 0.4 part by mass, particularly preferably from 0.03 part by mass to 0.15 part by mass with respect to 100 parts by mass of the polycarbonate resin serving as the component (A).

### <(E) Antioxidant>

An antioxidant can be incorporated as a component (E) into the polycarbonate resin composition (1) of the present invention as required. At least one kind selected from the group consisting of a phenol-based antioxidant, a phosphorus-based antioxidant, and a sulfur-based antioxidant can be used as the antioxidant.

The phenol-based antioxidant is not particularly limited, and a hindered phenol-based antioxidant is suitably used. Typical examples thereof include octadecyl-3-(3,5-di-tert-butyl-4-hydroxyphenyl)propionate, triethylene glycol-bis[3-(3-tert-butyl-5-methyl-4-hydroxyphenyl)propionate], 1,6-hexanediol-bis[3-(3,5-di-tert-butyl-4-hydroxyphenyl)propionate], pentaerythrityl-tetrakis[3-(3,5-di-tert-butyl-4-hydroxyphenyl)propionate], N,N′-hexamethylenebis[(3,5-di-tert-butyl-4-hydroxy)-hydrocinnamamide], 2,2-thio-diethylenebis[3-(3,5-di-tert-butyl-4-hydroxyphenyl)propionate], 2,4-bi s(n-octylthio)-6-(4-hydroxy-3 ,5-di-tert-butylanilino)-1,3,5-triazine, 1,3,5-trimethyl-2,4,6-tri s(3,5-di-tert-butyl-4-hydroxybenzyl)benzene, and tris-(3,5-di-tert-butyl-4-hydroxybenzyl)-isocyanurate.

The phosphorus-based antioxidant is not particularly limited, and examples thereof include triphenyl phosphite, diphenyl nonyl phosphite, diphenyl(2-ethylhexyl) phosphite, tris(2,4-di-tert-butylphenyl) phosphite, trisnonylphenyl phosphite, diphenyl isooctyl phosphite, 2,2′-methylenebis(4,6-di-tert-butylphenyl)octyl phosphite, diphenyl isodecyl phosphite, diphenyl mono(tridecyl) phosphite, phenyl diisodecyl phosphite, phenyl di(tridecyl) phosphite, tris(2-ethylhexyl) phosphite, tris(isodecyl) phosphite, tris(tridecyl) phosphite, dibutyl hydrogen phosphite, trilauryl trithiophosphite, tetrakis(2,4-di-tert-butylphenyl)-4,4′-biphenylene diphosphonite, 4,4′-isopropylidenediphenol dodecyl phosphite, 4,4′-isopropylidenediphenol tridecyl phosphite, 4,4′-isopropylidenediphenol tetradecyl phosphite, 4,4′-isopropylidenediphenol pentadecyl phosphite, 4,4′-butylidenebis(3-methyl-6-tert-butylphenyl) ditridecyl phosphite, 1,1,3-tris(2-methyl-4-tridecyl phosphite-5-tert-butylphenyl)butane, bis(2,6-di-tert-butylphenyl)pentaerythritol diphosphite, bis(2,4-dicumylphenyl)pentaerythritol diphosphite, 3,4:5,6-dibenzo-1,2-oxaphosphane, triphenylphosphine, diphenylbutylphosphine, diphenyloctadecylphosphine, tris-(p-tolyl)phosphine, tris-(p-nonylphenyl)phosphine, tris-(naphthyl)phosphine, diphenyl-(hydroxymethyl)-phosphine, diphenyl-(acetoxymethyl)-phosphine, diphenyl-(β-ethylcarboxyethyl)-phosphine, tris-(p-chlorophenyl)phosphine, tris-(p-fluorophenyl)phosphine, diphenylbenzylphosphine, diphenyl-β-cyanoethylphosphine, diphenyl-(p-hydroxyphenyl)-phosphine, diphenyl-1,4-dihydroxyphenyl-2-phosphine, and phenylnaphthylbenzylphosphine.

The content of the antioxidant is preferably from 0.003 part by mass to 0.5 part by mass, more preferably from 0.003 part by mass to 0.2 part by mass, still more preferably from 0.01 part by mass to 0.2 part by mass with respect to 100 parts by mass of the polycarbonate resin serving as the component (A). When the antioxidant is incorporated at a content within such range, the heat stability of the polycarbonate resin composition (1) of the present invention can be improved.

### <(F) Alicyclic Epoxy Compound>

An alicyclic epoxy compound can be incorporated as a component (F) into the polycarbonate resin composition (1) of the present invention as required. The alicyclic epoxy compound serving as the component (F) is a cyclic aliphatic compound having an alicyclic epoxy group, that is, an epoxy group in which one oxygen atom is added to an ethylene bond in an aliphatic ring. Specifically, compounds represented by the following formulae (1) to (10) described in JP 11-158364 A are each suitably used.

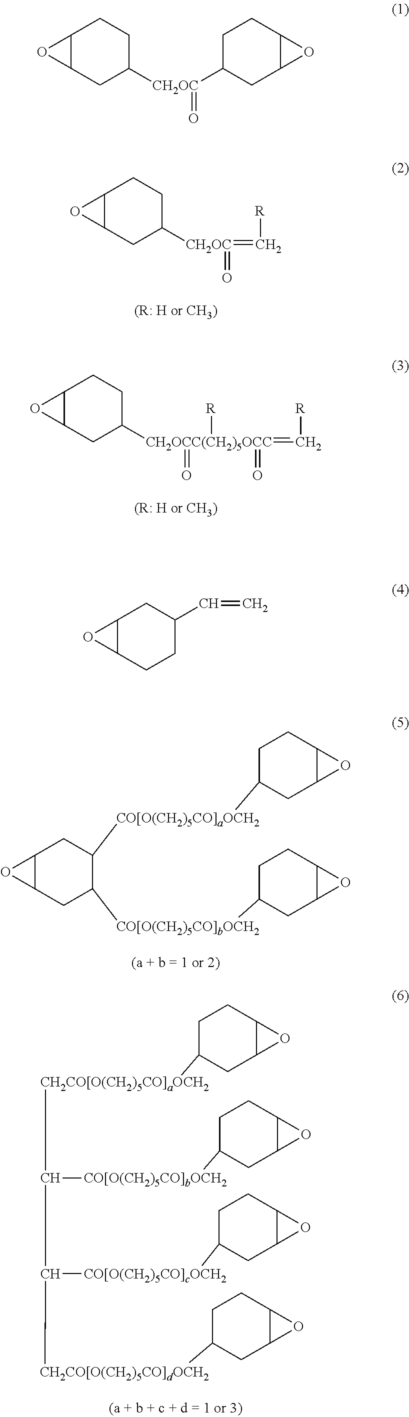

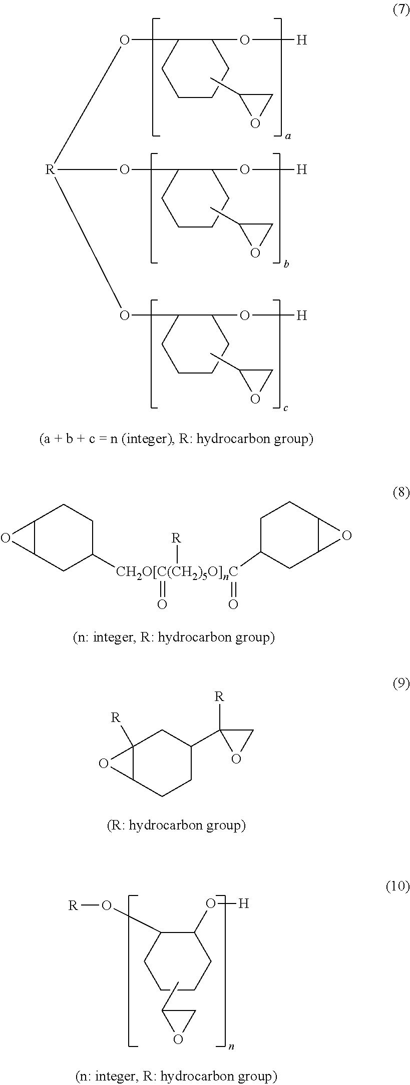

Among the alicyclic epoxy compounds, a compound represented by the formula (1), the formula (7), or the formula (10) is more preferably used because the compound is excellent in compatibility with the polycarbonate resin and hence does not impair its transparency.

The blending of the alicyclic epoxy compound into the polycarbonate resin can improve its hydrolysis resistance.

The content of the alicyclic epoxy compound serving as the component (F) is preferably from 0.005 part by mass to 0.05 part by mass with respect to 100 parts by mass of the polycarbonate resin serving as the component (A).

Any other additive, such as a UV absorber, a flame retardant, a flame retardant aid, a light stabilizer, a plasticizer, an antistatic agent, an antiblocking agent, an antimicrobial agent, a compatibilizer, a colorant (a dye or a pigment), a lubricant, or a reinforcing filler, such as a glass fiber, can be incorporated into the polycarbonate resin composition (1) of the present invention as required to the extent that the effects of the present invention are not impaired.

The polycarbonate resin composition (1) of the present invention is obtained by kneading predetermined amounts of the component (A), the component (B), the component (C), and as required, any other component. A method for the kneading is not particularly limited, and an example thereof is a method using a ribbon blender, a Henschel mixer, a Banbury mixer, a drum tumbler, a single-screw extruder, a twin-screw extruder, a co-kneader, a multi-screw extruder, or the like. An extruder including a melt filter between a heating cylinder and a die for reducing the amount of foreign matter in the resin composition can also be used. In normal cases, a heating temperature at the time of the kneading is preferably from 200° C. to 340° C., more preferably from 240° C. to 325° C. Thus, the polycarbonate resin composition (1) of the present invention can be obtained as a pellet or the like.

### [Polycarbonate Resin Composition (2)]

The polycarbonate resin composition (2) of the present invention is a polycarbonate resin composition containing, with respect to 100 parts by mass of (A) the polycarbonate resin, 0.01 part by mass to 0.25 part by mass of (B) the silicone compound, and 0.015 part by mass to 0.25 part by mass of (C) the ester of the aliphatic carboxylic acid having 12 to 22 carbon atoms and glycerin, wherein the modification ratio of the component (C) in the polycarbonate resin composition is 30% or less. The same polycarbonate resin as the polycarbonate resin serving as the component (A) to be used in the polycarbonate resin composition (1) of the present invention described above is used as the polycarbonate resin serving as the component (A). In addition, the same silicone compound as the silicone compound serving as the component (B) to be used in the polycarbonate resin composition (1) of the present invention described above is used as the silicone compound serving as the component (B). In addition, the same ester as the ester serving as the component (C) to be used in the polycarbonate resin composition (1) of the present invention described above is used as the ester of the aliphatic carboxylic acid having 12 to 22 carbon atoms and glycerin serving as the component (C).

The polycarbonate resin composition (2) of the present invention needs to contain 0.01 part by mass to 0.25 part by mass of the component (B), and 0.015 part by mass to 0.25 part by mass of the component (C). As in the case of the polycarbonate resin composition (1), a case in which the content of the component (B) is less than 0.01 part by mass is not preferred because when a molded article is obtained by using the polycarbonate resin composition (2), the heat stability of the molded article may reduce, and an appearance failure, such as silver, may occur on the surface of the molded article. In addition, a case in which the component (B) is incorporated at a content of more than 0.25 part by mass is also not preferred because the heat stability of the molded article cannot be further improved, but rather its YI is increased by a difference in refractive index between the component (B) and the polycarbonate resin serving as the component (A), and hence its light transmittance is impaired. The content of the component (B) is preferably from 0.03 part by mass to 0.20 part by mass, more preferably from 0.05 part by mass to 0.15 part by mass. The content of the component (B) in the polycarbonate resin composition (2) can be measured by gas chromatography.

In addition, in the polycarbonate resin composition (2) of the present invention, a case in which the content of the component (C) is less than 0.015 part by mass is not preferred because when a molded article is obtained by using the polycarbonate resin composition, its releasability deteriorates. In addition, a case in which the content of the component (C) is more than 0.25 part by mass is not preferred because there is a risk in that the component (C) adheres to the surface of a mold to adversely affect the surface appearance of a product. The content of the component (C) is preferably from 0.015 part by mass to 0.18 part by mass, more preferably from 0.03 part by mass to 0.10 part by mass. The content of the component (C) in the polycarbonate resin composition (2) can be measured by gas chromatography.

### <Modified Product of Component (C)>

The polycarbonate resin composition (2) of the present invention is obtained by kneading predetermined amounts of the component (A), the component (B), the component (C), and as required, any other component. An extensive investigation by the inventor has revealed that the ester of the aliphatic carboxylic acid having 12 to 22 carbon atoms and glycerin serving as the component (C) is liable to be modified by a production process for the composition, in particular, an influence by heat, and has found that a modified product of the component (C) is incorporated also into the polycarbonate resin composition (2) of the present invention by the kneading process. In particular, when the sodium content in the component (B) is more than 15 ppm by mass, the component (C) may be modified at a high modification ratio in the process. The modified product may be, for example, a compound having a carbonate ester structure as a result of a reaction between the two hydroxy groups of a monoester. The modified product is assumed to be a cause for the yellowing of a molded article of the composition. The content of the modified product of the component (C) in the polycarbonate resin composition (2) can also be measured by gas chromatography. The modified product is represented by the following formula (I):

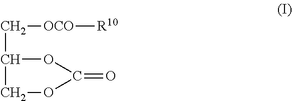

wherein in the formula (I), R¹⁰ represents an alkyl group having 11 to 21 carbon atoms.

### <Modification Ratio of Component (C)>

The modification ratio of the component (C) in the polycarbonate resin composition (2) of the present invention needs to be 30% or less. In the case where the modification ratio of the component (C) is set to 30% or less, when the pellet is turned into a molded article, an increase in yellow index of the molded article can be suppressed. The modification ratio of the component (C) can be determined as a ratio “[(content of modified product derived from component (C) in pellet)/[content of component (C) in pellet+content of modified product derived from component (C) in pellet]]×100 (%)” by measuring the content of the component (C) in the pellet formed of the polycarbonate resin composition (2) and the content of a modified product derived from the component (C) therein. The modification ratio of the component (C) is preferably 25% or less.

In order to set the modification ratio of the component (C) in the polycarbonate resin composition (2) to 30% or less, the content of sodium in the silicone compound serving as the component (B) is preferably set to 15 ppm by mass or less. A case in which the sodium content in the component (B) is excessively high is not preferred because a risk in that the modification ratio of the component (C) cannot be set to 30% or less occurs. As described in the description of the polycarbonate resin composition (1), a commercial compound can be used as the component (B). However, even the sodium content of the commercial compound may fluctuate, and even products that are available from the same manufacturer and are of the same grade may be different from each other in sodium content. Therefore, when the component (B) is used, the following procedure needs to be adopted: the sodium content in the component (B) is examined in advance, and the component (B) having a low sodium content is used; or the component is used after its sodium content has been reduced. The component (B) is colored pale yellow in some cases, and hence the component (B) colored to a small extent is desirably used.

A method involving performing an adsorption treatment with, for example, aluminum hydroxide, a synthetic hydrotalcite, magnesium silicate, aluminum silicate, or activated carbon has been known as a method of reducing the amount of a metal component, such as sodium, described above.

The polycarbonate resin composition (2) of the present invention may contain the component (D), the component (E), the component (F), or an additive except the foregoing described in the description of the polycarbonate resin composition (1) in addition to the component (B) and the component (C). Also in the case where the polycarbonate resin composition (2) contains the component (D), the component (E), the component (F), or the additive except the foregoing, the composition can be obtained so as to have the same content as that in the case of the polycarbonate resin composition (1) of the present invention. In addition, when the polycarbonate resin composition (2) of the present invention is obtained, as in the description of the polycarbonate resin composition (1), the composition is obtained by kneading predetermined amounts of the component (A), the component (B), the component (C), and as required, any other component. A method for the kneading is also not particularly limited, and the composition can be obtained by using, for example, a ribbon blender, a Henschel mixer, a Banbury mixer, a drum tumbler, a single-screw extruder, a twin-screw extruder, a co-kneader, or a multi-screw extruder.

### [Molded Articles]

Various molded articles can be obtained by molding involving using the polycarbonate resin composition (1) or (2) of the present invention.

Various conventionally known molding methods can each be used as a method of molding the pellet, and examples thereof include an injection molding method, an injection compression molding method, an extrusion molding method, a blow molding method, a press molding method, a vacuum molding method, and a foam molding method.

The components to be incorporated except the polycarbonate resin can be added after having been melt-kneaded together with the polycarbonate resin in advance, that is, as a master batch.

In addition, the polycarbonate resin composition (1) or (2) is preferably turned into an injection-molded article by pelletizing the composition and subjecting the pellet to injection molding. In the injection molding, a general injection molding method or a general injection compression molding method, or a special molding method, such as a gas assist molding method, can be used. Thus, the molded article can be produced.

Further, it is also preferred that the polycarbonate resin composition (1) or (2) be pelletized and then subjected to extrusion molding to provide a sheet-like molded body. When the sheet-like molded body is obtained by the extrusion molding, the sheet-like molded body can be produced by using a known extrusion molding machine, such as a T-die extruder.

A molding temperature in the production of the molded article is preferably from 240° C. to 320° C., more preferably from 250° C. to 320° C.

When the molded article of the present invention is used as an appearance member, a molding technology intended for an improvement in appearance, such as a heat cycle molding method, a high-temperature mold, or an insulated runner mold, can be used.

In addition, when it is required that a part be made flame-retardant, a molding technology, such as laminate molding or two-color molding with a resin material having flame retardancy, can be used.

In order to obtain a large and thin-walled injection-molded body, injection compression molding, or high-pressure or ultrahigh-pressure injection molding can be used, and in the molding of a molded article having a partial thin-walled portion, partial compression molding or the like can be used.

The molded article of the present invention can be used in various applications including: lighting covers; protective covers; casings for OA equipment, a copying machine, and a home electric appliance; lenses; electrical and electronic parts; and window products; the molded article can be suitably used particularly as an optical molded article utilizing light permeability, more specifically, as a light-guiding part because its releasability is not reduced, the molded article hardly yellows, and the occurrence of a failure of the molded article, such as silver, can be prevented. Such light-guiding part can be suitably used particularly as: a light-guiding plate for a liquid crystal display (light-guiding plate for a liquid crystal panel) of a smartphone, a laptop personal computer, a television, or the like; or a light-guiding part for a vehicle, such as an automobile, a railway vehicle, or a motorized bicycle. In recent years, a daytime running light has been widely used in areas typified by Europe for improving the visibility of an automobile in the daytime, and in a twilight time zone before and after sunset. The molded article using the polycarbonate resin composition (1) or (2) of the present invention can be suitably utilized as light-guiding parts for vehicles including a light-guiding part for an automobile intended for a daytime running light.

### EXAMPLES

The present invention is hereinafter described in more detail by way of Examples. The present invention is not limited by these Examples. Measurements and evaluations in Examples and Comparative Examples were performed by the following methods.

### <Sodium (Na) Content>

Sodium (Na) contents in raw materials to be used were each determined by: adding sulfuric acid to 5 g of each of the measurement samples (raw materials to be used); subjecting the mixture to a heat ashing treatment; then dissolving the resultant in an aqueous solution of hydrochloric acid; and subjecting the aqueous solution to measurement based on inductively coupled plasma-atomic emission spectroscopy (ICP-AES). 720-ES manufactured by Agilent Technologies, Inc. was used as a measuring machine. A determination lower limit by the measurement is 200 ppb by mass.

### <Contents of Component (C) and Modified Product of Component (C) in Pellet>

2.0 g of a pellet formed of a polycarbonate resin composition was dissolved in 15 mL of chloroform. 25 mL of methanol was added to the solution to reprecipitate a polycarbonate, and the mixture was left at rest. After that, 20 mL of a supernatant was concentrated to dryness. The resultant dried product was redissolved in 3 mL of DMF, and a silylation treatment was performed by adding 1 mL of an N,O-bis(trimethylsilyl)acetamide (BSA) reagent to the solution and stirring the mixture. The resultant reaction product was subjected to quantitative analysis by mounting a gas chromatograph including a hydrogen flame ionization detector (“Model 7890A” manufactured by Agilent Technologies, Inc.) with a column “DB-1” (having a length of 15 m, a diameter of 0.53 mm, and an inner diameter of 1.5 pm). The following conditions were adopted as measurement conditions.

The temperature of an injection port was 330° C., the temperature of the detector was 330° C., the temperature of an oven was increased from 120° C. to 330° C. under the condition of a rate of temperature increase of 10° C./min, and the reaction product was injected in an amount of 1 μL.

The contents of the component (C) and a modified product derived from the component (C), the modified product being represented by the following formula (II), were each determined by using a calibration curve created in advance, and a modification ratio was determined by the following method. A determination lower limit by the measurement is 30 ppm by mass.

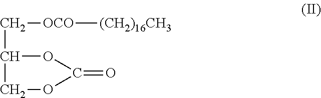

The modification ratio of the component (C) was determined as a ratio “[(content of modified product derived from component (C) in pellet)/[content of component (C) in pellet+content of modified product derived from component (C) in pellet]]×100 (%).” When the content of the modified product derived from the component (C) in the pellet was less than the determination lower limit, that is, 30 ppm by mass, the term “incalculable” was described.

### <Measurement of YI Value>

In recent years, an increase in size of a molded article and the thinning thereof have been advancing, and hence a resin is molded at a temperature higher than the recommended cylinder temperature setting of a molding machine in some cases. Accordingly, the YI value of a molded body was evaluated at 350° C. serving as a severer temperature condition.

A pellet formed of a polycarbonate resin composition was subjected to injection molding with an injection molding machine at an injection molding temperature of 350° C. to provide a flat-plate test piece having a size measuring 30 mm by 20 mm by 3 mm thick. The yellow index (YI) value of the test piece was measured with a spectrophotometer “SE-2000” (manufactured by Nippon Denshoku Industries Co., Ltd.) under the conditions of a C light source and a two-degree field of view. As the numerical value becomes higher, the yellow index of the test piece is higher, which means that the test piece is colored to a larger extent. In the measurement of the YI value, the YI values of a flat-plate test piece molded in a normal cycle (retention time: 30 seconds) and a flat-plate test piece molded by retaining the pellet in the injection molding machine for 10 minutes were measured and determined. A higher YI value after the retention for 10 minutes means that the test piece is poorer in heat resistance. The injection molding was performed while the cylinder temperature of the injection molding machine was kept at 350° C.

### <Evaluation of Releasability>

When the flat-plate test piece obtained by the injection molding in the measurement of the YI value was removed from a mold, its releasability was evaluated by the following criteria.

A: The flat-plate test piece was able to be removed from the mold without its breakage.

B: When the flat-plate test piece was removed from the mold, the breakage of part of the flat-plate test piece was observed.

### <Presence or Absence of Occurrence of Silver>

The surface appearance (presence or absence of the occurrence of silver) of the flat-plate test piece obtained by the molding after the retention in the injection molding machine for 10 minutes was visually evaluated in accordance with the following evaluation criteria.

A: No silver is observed.

B: Silver is observed.

### Examples 1 to 9 and Comparative Examples 1 to 5

The components (A) to (E) were used in blending amounts shown in Table 1, and were melt-kneaded with a vented twin-screw extruder (manufactured by Toshiba Machine Co., Ltd., “TEM-3755,” L/D=40.5) at a cylinder temperature of 320° C. to provide pellets. The pellets were each obtained by melt-kneading the components with the vented twin-screw extruder while, in the melt kneading, adding 0.1 part by mass of ion-exchanged water (electrical conductivity: 1 μS/m or less) with respect to 100 parts by mass of the component (A) from the raw material-loading port of the extruder and reducing a pressure at the outlet of a vent to a vacuum degree of −720 mmHg. The results of the evaluations of the resultant pellets each formed of a polycarbonate resin composition and the results of the evaluations of test pieces obtained by subjecting the pellets to injection molding are shown in Table 1. Silicone compounds of the same grade available under the product name “KR-511” from Shin-Etsu Chemical Co., Ltd. were used as silicone compounds serving as the components (B) used in Examples and Comparative Examples, and 5 lots of silicone compounds “KR-511 (a) to KR-511 (e),” which were of the same grade but were different from one another in sodium content, and KR-511 (f), which had been obtained by reducing the sodium content of KR-511 (e), were used.

TABLE 1

| | | | | Example | | | | |
|---|---|---|---|---|---|---|---|---|
| | | | | 1 | 2 | 3 | 4 | 5 |
| Composition | (A) | Polycarbonate resin | FN1500*¹ | 100 | 100 | 100 | 100 | 100 |
| of blend | | | FN1700*² | — | — | — | — | — |
| (part(s) by | (B) | Silicone compound | KR-511(a)*³ | 0.1 | — | — | — | — |
| mass) | | | KR-511(b)*⁴ | — | 0.1 | — | 0.1 | 0.1 |
| | | | KR-511(c)*⁵ | — | — | 0.1 | — | — |
| | | | KR-511(d)*⁶ | — | — | — | — | — |
| | | | KR-511(e)*⁷ | — | — | — | — | — |
| | | | KR-511(f)*⁸ | — | — | — | — | — |
| | (C) | Glycerin ester | S-100A*⁹ | 0.03 | 0.03 | 0.03 | 0.015 | 0.05 |
| | (D) | Acrylic resin | BR-83*¹⁰ | 0.1 | 0.1 | 0.1 | 0.1 | 0.1 |
| | (E) | Antioxidant | PEP-36*¹¹ | 0.05 | 0.05 | 0.05 | 0.05 | 0.05 |
| | (F) | Alicyclic epoxy | Cel-2021P*¹² | — | — | — | — | — |

| Content of component (C) in pellet (part(s) by mass) | | 0.027 | 0.021 | 0.017 | 0.015 | 0.040 |
|---|---|---|---|---|---|---|
| Content of modified product of component (C) in pellet | | Measurement | 0.003 | 0.005 | Measurement | 0.005 |
| (part(s) by mass) | | lower limit | | | lower limit | |
| Modification ratio of component (C) (%) | | Incalculable | 12 | 23 | Incalculable | 13 |
| YI value (YI retention test, | Normal cycle | 1.2 | 1.1 | 1.2 | 1.2 | 1.2 |
| 3-millimeter thick, flat plate) | Retention for 10 minutes | 1.4 | 1.3 | 1.4 | 1.4 | 1.4 |

| | | | | | |
|---|---|---|---|---|---|
| Releasability | A | A | A | A | A |
| Presence or absence of occurrence of silver | A | A | A | A | A |

| | | | | Example | | | |
|---|---|---|---|---|---|---|---|
| | | | | 6 | 7 | 8 | 9 |
| Composition | (A) | Polycarbonate resin | FN1500*¹ | 100 | 100 | — | 100 |
| of blend | | | FN1700*² | — | — | 100 | — |
| (part(s) by | (B) | Silicone compound | KR-511(a)*³ | 0.05 | 0.15 | 0.1 | — |
| mass) | | | KR-511(b)*⁴ | — | — | — | — |
| | | | KR-511(c)*⁵ | — | — | — | — |
| | | | KR-511(d)*⁶ | — | — | — | — |
| | | | KR-511(e)*⁷ | — | — | — | — |
| | | | KR-511(f)*⁸ | — | — | — | 0.15 |
| | (C) | Glycerin ester | S-100A*⁹ | 0.03 | 0.03 | 0.03 | 0.03 |
| | (D) | Acrylic resin | BR-83*¹⁰ | 0.1 | 0.1 | 0.1 | 0.1 |
| | (E) | Antioxidant | PEP-36*¹¹ | 0.05 | 0.05 | 0.05 | 0.05 |
| | (F) | Alicyclic epoxy | Cel-2021P*¹² | — | — | 0.03 | — |

| Content of component (C) in pellet (part(s) by mass) | | 0.026 | 0.027 | 0.029 | 0.029 |
|---|---|---|---|---|---|
| Content of modified product of component (C) in pellet | | Measurement | Measurement | Measurement | Measurement |
| (part(s) by mass) | | lower limit | lower limit | lower limit | lower limit |
| Modification ratio of component (C) (%) | | Incalculable | Incalculable | Incalculable | Incalculable |
| YI value (YI retention test, | Normal cycle | 1.1 | 1.2 | 1.2 | 1.2 |
| 3-millimeter thick, flat plate) | Retention for 10 minutes | 1.3 | 1.4 | 1.4 | 1.4 |

| | | | | |
|---|---|---|---|---|
| Releasability | A | A | A | A |
| Presence or absence of occurrence of silver | A | A | A | A |

| | | | | Comparative Example | | | | |
|---|---|---|---|---|---|---|---|---|
| | | | | 1 | 2 | 3 | 4 | 5 |
| Composition | (A) | Polycarbonate resin | FN1500*¹ | 100 | 100 | 100 | 100 | 100 |
| of blend | | | FN1700*² | — | — | — | — | — |
| (part(s) by | (B) | Silicone compound | KR-511(a)*³ | — | — | — | 0.3 | — |
| mass) | | | KR-511(b)*⁴ | — | — | — | — | — |
| | | | KR-511(c)*⁵ | — | — | 0.1 | — | — |
| | | | KR-511(d)*⁶ | 0.1 | — | — | — | — |
| | | | KR-511(e)*⁷ | — | — | — | — | 0.1 |
| | | | KR-511(f)*⁸ | — | — | — | — | — |
| | (C) | Glycerin ester | S-100A*⁹ | 0.03 | 0.03 | — | 0.04 | 0.03 |
| | (D) | Acrylic resin | BR-83*¹⁰ | 0.1 | 0.1 | 0.1 | 0.1 | 0.1 |
| | (E) | Antioxidant | PEP-36*¹¹ | 0.05 | 0.05 | 0.05 | 0.05 | 0.05 |
| | (F) | Alicyclic epoxy | Cel-2021P*¹² | — | — | — | — | — |

| Content of component (C) in pellet (part(s) by mass) | | 0.014 | 0.029 | — | 0.029 | 0.012 |
|---|---|---|---|---|---|---|
| Content of modified product of component (C) in pellet | | 0.007 | Measurement | — | 0.010 | 0.012 |
| (part(s) by mass) | | | lower limit | | | |
| Modification ratio of component (C) (%) | | 33 | Incalculable | — | 26 | 50 |
| YI value (YI retention test, | Normal cycle | 1.2 | 1.1 | 1.2 | 1.5 | 1.3 |
| 3-millimeter thick, flat plate) | Retention for 10 minutes | 1.6 | 1.3 | 1.4 | 1.8 | 1.6 |

| | | | | | |
|---|---|---|---|---|---|
| Releasability | A | A | B | A | A |
| Presence or absence of occurrence of silver | A | B | A | A | A |

*¹FN1500: bisphenol A polycarbonate resin (manufactured by Idemitsu Kosan Co., Ltd., viscosity-average molecular weight (Mv): 14,400, sodium content: less than 0.2 ppm by mass)
*²FN1700: bisphenol A polycarbonate resin (manufactured by Idemitsu Kosan Co., Ltd., viscosity-average molecular weight (Mv): 17,700, sodium content: less than 0.2 ppm by mass)
*³KR-511(a): silicone compound having a methoxy group and a vinyl group as functional groups (manufactured by Shin-Etsu Chemical Co., Ltd., refractive index: 1.518, sodium content: 4 ppm by mass)
*⁴KR-511(b): silicone compound having a methoxy group and a vinyl group as functional groups (manufactured by Shin-Etsu Chemical Co., Ltd., refractive index: 1.518, sodium content: 10 ppm by mass)
*⁵KR-511(c): silicone compound having a methoxy group and a vinyl group as functional groups (manufactured by Shin-Etsu Chemical Co., Ltd., refractive index: 1.518, sodium content: 13 ppm by mass)
*⁶KR-511(d): silicone compound having a methoxy group and a vinyl group as functional groups (manufactured by Shin-Etsu Chemical Co., Ltd., refractive index: 1.518, sodium content: 18 ppm by mass)
*⁷KR-511(e): silicone compound having a methoxy group and a vinyl group as functional groups (manufactured by Shin-Etsu Chemical Co., Ltd., refractive index: 1.518, sodium content: 25 ppm by mass)
*⁸KR-511 (f): 1 g of KYOWAAD 700 (manufactured by Kyowa Chemical Industry Co., Ltd., an adsorbent containing synthetic aluminum silicate as a main component) was added to 100 mL of the KR-511 (e) (sodium content: 25 ppm by mass), and the mixture was subjected to a stirring adsorption treatment for 8 hours, followed by the separation of the KYOWAAD by filtration with a 0.2-micrometer PTFE filter. The silicone compound after the adsorption treatment was obtained as the KR-511 (f). The sodium content in the resultant KR-511 (f) was 1 ppm by mass or less.
*⁹S-100A: glycerin monostearate (manufactured by Riken Vitamin Co., Ltd., product name: RIKEMAL S-100A, sodium content: less than 2 ppm by mass)
*¹⁰BR-83: acrylic resin (manufactured by Mitsubishi Rayon Co., Ltd., product name: Dianal BR83, Tg = 75° C., weight-average molecular weight: 40,000, sodium content: less than 1 ppm by mass)
*¹¹PEP-36A: phosphorus-based antioxidant, bis(2,6-di-tert-butylphenyl)pentaerythritol diphosphite [manufactured by ADEKA Corporation, product name: ADEKA STAB PEP-36A, sodium content: less than 1 ppm by mass]
*¹²Cel-2021P: 3,4-epoxycyclohexylmethyl-3′,4′-epoxycyclohexanecarboxylate, product name “Celloxide 2021P”, manufactured by Daicel Corporation

The results of Table 1 show that when a molded article is obtained by using any one of the polycarbonate resin compositions obtained in Examples 1 to 9, even under severe molding conditions, such as high-temperature molding and a long retention time, the molded article hardly yellows, its releasability is not reduced, and the occurrence of silver is prevented. Meanwhile, the results of Table 1 show that when a molded article is obtained by using any one of the polycarbonate resin compositions obtained in Comparative Examples 1 to 5, its releasability reduces, the molded article yellows, or silver occurs in the molded article.

### INDUSTRIAL APPLICABILITY

In the polycarbonate resin composition and the molded article obtained from the polycarbonate resin composition of the present invention, even under severe molding conditions, such as high-temperature molding and a long retention time, the molded article hardly yellows, its releasability is not reduced, and the occurrence of a failure of the molded article, such as silver, can be prevented. Accordingly, the polycarbonate resin composition and the molded article thereof can be used in various applications including: lighting covers; protective covers; casings for OA equipment, a copying machine, and a home electric appliance; optical molded articles, such as a lens and a light-guiding part; electrical and electronic parts; and window products. In particular, the polycarbonate resin composition and the molded article thereof can be suitably used in: light-guiding plates for liquid crystal displays (light-guiding plates for liquid crystal panels) of a smartphone, a laptop personal computer, a television, and the like; and light-guiding parts for vehicles including a light-guiding part for an automobile intended for a daytime running light.

1. A polycarbonate resin composition, comprising:
a polycarbonate resin serving as a component (A);
a silicone compound serving as a component (B); and
an ester of an aliphatic carboxylic acid having 12 to 22 carbon atoms and glycerin serving as a component (C),
wherein the polycarbonate resin composition comprises, with respect to 100 parts by mass of the component (A), 0.01 part by mass or more and 0.25 part by mass or less of the component (B), and 0.015 part by mass or more and 0.25 part by mass or less of the component (C), and
wherein a sodium content in the component (B) is 15 ppm by mass or less.

2. The polycarbonate resin composition according to claim 1, wherein a sodium content in the component (A) is 200 ppb by mass or less.

3. The polycarbonate resin composition according to claim 1, wherein a sodium content in the component (C) is 2 ppm by mass or less.

4. The polycarbonate resin composition according to claim 1, wherein the component (C) comprises an ester of stearic acid and glycerin.

5. The polycarbonate resin composition according to claim 4, wherein the ester of stearic acid and glycerin comprises glycerin monostearate.

6. The polycarbonate resin composition according to claim 1, wherein the component (B) comprises a silicone compound in which at least one kind selected from the group consisting of a hydrogen atom, an alkoxy group, a hydroxy group, an epoxy group, and a vinyl group is bonded to a silicon atom.

7. The polycarbonate resin composition according to claim 1, wherein the component (A) comprises an aromatic polycarbonate resin.

8. The polycarbonate resin composition according to claim 1, wherein the component (A) has a viscosity-average molecular weight of 9,000 or more and 30,000 or less.

9. The polycarbonate resin composition according to claim 1, wherein the component (A) has a viscosity-average molecular weight of 10,000 or more and 20,000 or less.

10. The polycarbonate resin composition according to claim 1, further comprising, with respect to 100 parts by mass of the component (A), 0.01 part by mass or more and 0.5 part by mass or less of an acrylic resin serving as a component (D).

11. The polycarbonate resin composition according to claim 1, further comprising, with respect to 100 parts by mass of the component (A), 0.003 part by mass or more and 0.2 part by mass or less of an antioxidant serving as a component (E).

12. A polycarbonate resin composition, comprising:
a polycarbonate resin serving as a component (A);
a silicone compound serving as a component (B); and
an ester of an aliphatic carboxylic acid having 12 to 22 carbon atoms and glycerin serving as a component (C),
wherein the polycarbonate resin composition comprises, with respect to 100 parts by mass of the component (A), 0.01 part by mass or more and 0.25 part by mass or less of the component (B), and 0.015 part by mass or more and 0.25 part by mass or less of the component (C), and
wherein a modification ratio of the component (C) in the polycarbonate resin composition is 30% or less.

13. A molded article, which is obtained by molding the polycarbonate resin composition of claim 1.

14. The molded article according to claim 13, wherein the molded article comprises an optical molded article.

15. The molded article according to claim 14, wherein the optical molded article comprises a light-guiding plate for a liquid crystal panel.

16. The molded article according to claim 14, wherein the optical molded article comprises a light-guiding part for a vehicle.
